(19) United States
(12) Patent Application Publication
(10) Pub. No.: US 2013/0287234 A1
(43) Pub. Date: Oct. 31, 2013

(54) Flat Ceiling Mounted Loudspeaker

(71) Applicant: Joseph Kramer, Mevasseret Zion (IL)

(72) Inventor: Joseph Kramer, Mevasseret Zion (IL)

(73) Assignee: KRAMER ELECTRONICS LTD., Jerusalem (IL)

(21) Appl. No.: 13/455,639

(22) Filed: Apr. 25, 2012

(51) Int. Cl. H04R 5/02

(52) U.S. Cl. 381/304; 381/307

(57) ABSTRACT

A ceiling speaker mountable in a ceiling tile for mounting in a suspended ceiling of a room, includes a central woofer, and at least four surrounding pivoting tweeters that are independently adjustable so as to provide broad flat coverage throughout the room. A crossover network directs low frequency signals to the woofer and high frequency signals to the tweeters and an optional stereo separator circuit directs left and right signals to different pairs of the tweeters. A method for adjusting sound dispersion produced by the ceiling speaker is also disclosed.

### FIELD OF THE INVENTION

This invention relates to ceiling mounted loudspeakers.

### BACKGROUND OF THE INVENTION

Ceiling mounted loudspeakers mountable in a ceiling tile adapted for mounting in a suspended ceiling of a room are known. They are particularly applicable to lecture theaters attended by large audiences. FIG. 1 shows pictorially that the sound dispersion produced by known ceiling mounting speakers is typically limited to a cone that covers only a small part of the room. In order to provide coverage across the complete area of the room, a number of speakers can be cascaded, each being mounted at the apex of its respective cone. This improves audibility but gives rise to unequal sound dispersion, whereby the sound pressure level (SPL) varies according to where a person sits in the room. The actual listening plane of a conventional 140° ceiling loudspeaker covers 90-100°.

### SUMMARY OF THE INVENTION

It is an object of the invention to provide a ceiling speaker for mounting in a ceiling tile which produces much improved sound dispersion.

This object is achieved in accordance with the invention by a ceiling speaker mountable in a ceiling tile for mounting in a suspended ceiling of a room, said ceiling speaker comprising:

a central woofer,

at least four surrounding pivoting tweeters that are independently adjustable so as to provide broad flat coverage throughout the room, and

a crossover network for directing low frequency signals to the woofer and high frequency signals to the tweeters.

Preferably there is also provided a stereo separator circuit for directing left and right signals to different pairs of tweeters. Provision of stereo in a unitary ceiling loud-speaker unit requiring only a single unit is not taught in hitherto-proposed ceiling units.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a pictorial representation comparing sound dispersion in a room produced by known ceiling mounting speakers and the ceiling mounting speaker according to the invention;

FIG. 2 is a pictorial representation of a ceiling speaker according to the invention mounted in a full tile;

FIG. 3 is a block diagram showing functionality of the speaker shown in FIG. 2;

FIGS. 4 and 5 show pictorially details of a ceiling speaker according to the invention mounted in a half tile; and

FIGS. 6 and 7 are sectional views showing further constructional details of the ceiling speaker according to the invention.

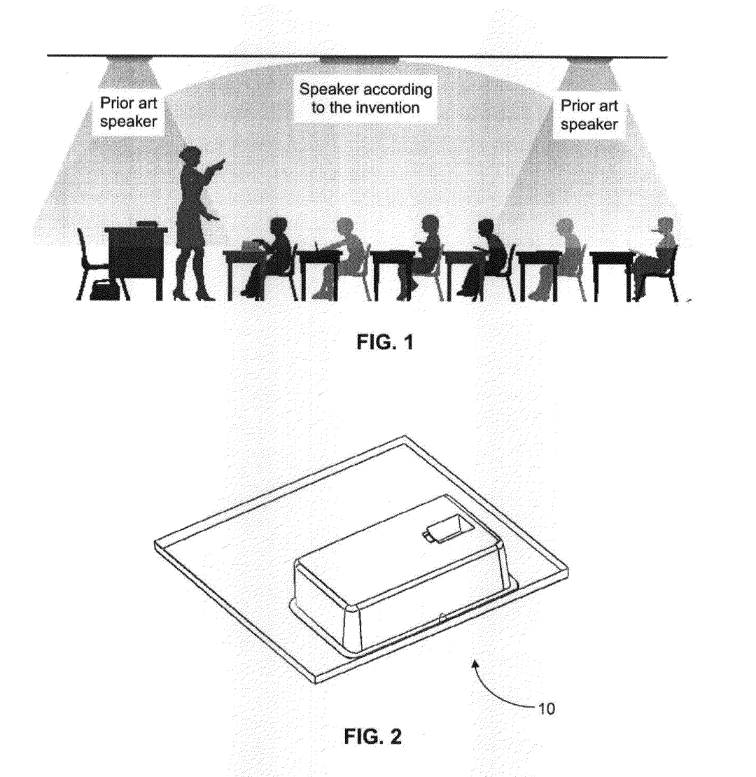

### DETAILED DESCRIPTION OF EMBODIMENTS

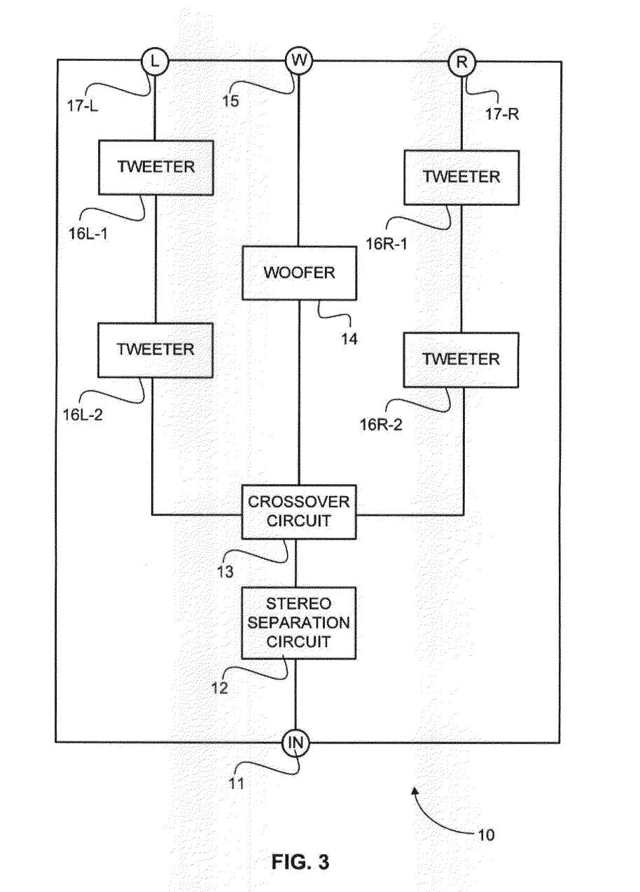

FIGS. 2 and 3 show pictorially and functionally a ceiling speaker 10 mountable in a ceiling tile for mounting in a suspended ceiling of a room. The ceiling speaker comprises an audio input 11 coupled via a stereo separation circuit 12 and a crossover circuit 13 to a central woofer 14 coupled to an output terminal (W) 15. Also provided are at least four surrounding pivoting tweeters 16L-1, 16L-2, 16R-1 and 16R-2 that are independently adjustable so as to provide broad flat coverage throughout the room. The tweeters 16L-1, 16L-2 are commonly coupled to a left output (L) 17 while the tweeters 16R-1, 16R-2 are commonly coupled to a right output (R) 18. The crossover circuit 13 is configured for directing low frequency signals to the woofer and high frequency signals to the tweeters in known manner. The stereo separation circuit 12 is configured for directing left and right signals to different pairs of tweeters also in known manner.

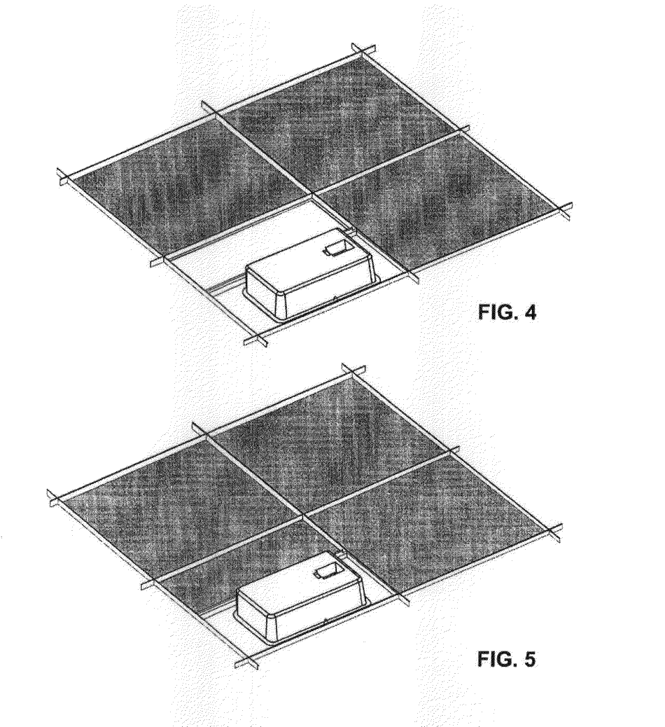

The ceiling speaker may be dimensioned to fit in a full-size ceiling tile as shown in FIG. 2 or it may be dimensioned to fit in a half-size ceiling tile as shown in FIGS. 4 and 5.

In an embodiment of the invention reduced to practice, an 8-inch woofer and four ¾-inch tweeters were employed and the speaker had an impedance of 8 Ω.

It has been found that when installing conventional round ceiling speakers in a room with a standard ceiling height of 2.7 m (8.8 feet), the optimal distance between speakers is about four meters. A 10 m×5 m room size would thus optimally require four conventional ceiling speakers for the full room. However, all four conventional speakers may be replaced by a single flat speaker according to the invention, which is best installed lengthwise relative to the shape of the room. It has been found that compared with a conventional 140° ceiling speaker, such an arrangement produces an improved listening plane that covers 180° having improved sound quality.

If the size of the room requires only a single speaker, a mono or stereo speaker may be utilized for speech and music. When stereo is required, the left and right signals are separated by the stereo separation unit. When mono is required, this is not done and the combined signal is sent to each speaker.

If the size of the room requires more than one speaker, it is preferable to use two mono speakers, which are connected to the left and right connectors of the amplifier, respectively.

Once the location of the speaker is fixed, the speaker is adjusted for operation as follows:
1. Move each of the pivoting tweeters outward in an angle that is suited to the room shape and size.
2. Run the wires from the amplifier through the ceiling.
3. Remove the ceiling tile at the place where you plan to install the speaker.
4. Connect the speaker wires to the speaker terminals (see FIG. 3) from the adjacent ceiling tile opening.
5. Place the speaker temporarily in place, and test the audio quality.
6. If the audio quality is good for all parts of the room, disconnect the amplifier and remove the speaker from the ceiling. If not, change the position of the tweeters and check the audio quality again until the results are acceptable.
7. Fit the speaker grille over the speaker underside and tighten with screws.

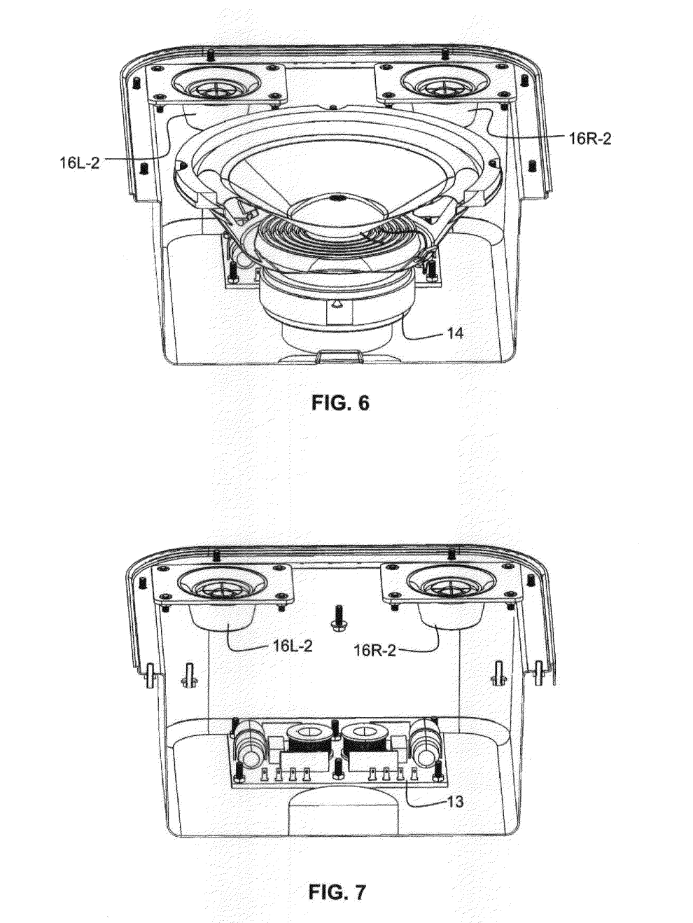

FIGS. 6 and 7 are sectional views showing further constructional details of the ceiling speaker 10 according to the invention.

1. Ceiling speaker mountable in a ceiling tile for mounting in a suspended ceiling of a room, said ceiling speaker comprising:
a central woofer,
at least four surrounding pivoting tweeters that are independently adjustable so as to provide broad flat coverage throughout the room, and
a crossover network for directing low frequency signals to the woofer and high frequency signals to the tweeters.

2. The ceiling speaker according to claim 1, having a stereo separator circuit for directing left and right signals to different pairs of tweeters.

3. The ceiling speaker according to claim 1 being dimensioned to fit in a full-size ceiling tile.

4. The ceiling speaker according to claim 1 being dimensioned to fit in a half-size ceiling tile.

5. A method for adjusting sound dispersion produced by a ceiling speaker mounted in a suspended ceiling of a room, said ceiling speaker comprising:
a central woofer,
at least four surrounding pivoting tweeters that are independently adjustable so as to provide broad flat coverage throughout the room, and
a crossover network for directing low frequency signals to the woofer and high frequency signals to the tweeters;
the method comprising:
moving each of the pivoting tweeters outward at an angle that is suited to the room shape and size or to a portion thereof so that the tweeters direct sound to all areas of the room or of said portion of the room, and
listening to sound produced by the ceiling speaker and manually adjusting a position of the tweeters until audio quality is acceptable.
